(19) United States
(12) Patent Application Publication
(10) Pub. No.: US 2016/0229505 A1
(43) Pub. Date: Aug. 11, 2016

(54) Sailcloth of Nonwoven Fabric Material

(71) Applicant: DIMENSION-POLYANT GMBH, Kempen (DE)

(72) Inventors: Heiner Schillings, Heinsberg (DE); Luc Laurenzatto, Marseille (FR)

(21) Appl. No.: 15/024,224

(22) PCT Filed: Sep. 22, 2014
(86) PCT No.: PCT/EP2014/070088

§ 371 Date: Mar. 23, 2016

(30) Foreign Application Priority Data
Sep. 23, 2013 (DE) 10 2013 015 669.6

(51) Int. Cl. B63H 9/06; B32B 5/10; B32B 5/26; B32B 5/02; B32B 5/12

(52) U.S. Cl. CPC B63H 9/0657; B32B 5/022; B32B 5/12; B32B 5/26; B32B 5/10; B32B 2250/20; B32B 2262/0284; B32B 2262/0269; B32B 2262/0253; B32B 2262/106; B32B 2307/718; B32B 2307/516; B32B 2307/518; B32B 2307/734; B32B 2605/12; B63H 2009/0678

(57) ABSTRACT

A sailcloth including at least one textile layer, wherein at least one textile layer consists of a nonwoven fabric material with unidirectionally or bidirectionally aligned filaments.

### TECHNICAL FIELD

The invention relates to a sailcloth including at least one textile layer of a nonwoven fabric material.

### BACKGROUND

When manufacturing high-performance sails, also for regatta purposes, it is an essential requirement to combine quite a number of special characteristics such as low weight, good handling qualities, low permeability to wind, high tearing resistance, excellent form stability, low water absorptiveness, and similar properties. Therefore, the ultimate goal sailcloth makers have in mind is to create an optimized cloth for sail manufacturing which purposefully features all these characteristics.

To optimize the strength properties of a sail, reinforcing yarns are frequently integrated into sailcloth webs, said yarns forming their own layers between two outer layers. For said outer layers polyester sheets or dense woven polyester fabric may be employed, for example Kevlar®, an aramid fiber, is often used for the yarns of the inner layers arranged between the outer layers. The yarns laid between the outer layers are arranged in a more or less regular pattern of parallel strands which are extending at various angles in relation to the longitudinal direction (machine direction) of the sailcloth.

Thanks to the reinforcing yarns provided, sailcloth manufactured in this manner has high strength and load carrying ability but on the other hand its mass per unit area is also relatively high. The mass per unit area becomes higher the higher the requirements with respect to tightness and strength of the outer layers which are to be met. It is also to be noted in this context that high-strength materials such as polyamides tend to absorb water which additionally results in an increase of the mass per unit area of a sail when used.

Sails reinforced by yarns are for instance known from DE 39 28 312 A1. The composed sails described in that publication consist of a carrier layer of a woven fabric, a finishing layer consisting of sheet material, and of reinforcing yarns laid in between in an adhesive bed, said yarns may, for example, be made of aramid fibers (Kevlar®). The yarns of the intermediate layer are arranged parallelly to each other and extend transversely to the reinforcing yarns integrated into the carrier layer. The reinforcing yarns located in the carrier layer run along the main loading direction of the relevant cloth segment in the finished sail. All in all, a pattern is obtained that consists of reinforcing yarns extending vertically to each other in the sailcloth.

The mass per unit area of the materials used in conventional sailcloth for the outer layers (carrier and finishing layer) is relatively high. Additionally, the weight of the absorbed water is to be taken into account. This high mass per unit area is to be regarded a handicap that not only influences the performance of the sail negatively but also the way the sail can be handled by the crew.

### SUMMARY

It is, therefore, the objective of the present invention to provide material that enables said high mass per unit area to be reduced.

As proposed by the present invention this objective is accomplished by providing a sailcloth of the kind first mentioned above, wherein at least one textile layer consists of a nonwoven fabric material comprising unidirectionally or bidirectionally aligned filaments.

Unidirectional means the filaments extend parallelly in one direction. Unidirectionally aligned filaments preferably extend in machine direction (0°).

Bidirectionally aligned filaments are crossing each other in two directions of which one direction preferably being the machine direction. Filaments crossing each other are preferably aligned at a 90° direction relative to the machine direction.

Nonwoven fabric materials of said kind are basically known and have been described in EP 2 578 734 A1, for example. These nonwoven materials feature a carrier matrix consisting of threads arranged orthogonally to each other onto which a plurality of parallelly aligned filaments is applied. The carrier matrix forms a wide-meshed net, the filaments arranged thereon are preferably endless filaments, the length of which being determined by the length of the nonwoven fabric material in machine direction. The unidirectionally aligned filaments extend parallelly to the longitudinal direction of the carrier matrix, that is, the transversely extending threads of the carrier matrix also extend transversely to the filaments (90°). The filament layer and the carrier matrix are connected with each other, for example by thermal welding, pressure, a combination of these methods or by means of ultrasound. An adhesive method may also be employed. The filaments extend in machine direction and determine the 0° alignment.

Moreover, bidirectional nonwoven fabric materials are known that, in addition to the 0° direction, are provided with filaments extending in 90° direction, i.e. transversely to the machine direction.

### DETAILED DESCRIPTION

The nonwoven fabrics employed as proposed by the invention have a mass per unit area ranging between 20 and 100 g/m², in particular between 30 and 60 g/m² and especially preferred of approx. 40 g/m². Suitable materials are filaments made of thermoplastic materials, for example polyester, polyethylene, polypropylene, ethylene vinyl acetate (EVA) copolymer, polyamide (nylon), and the like, with polyester being preferred, in particular polyethylene terephthalate. However, combinations of such materials may be employed as well.

The inventive sailcloth is provided with at least one layer, preferably an outer layer, made of the nonwoven fabric material herein described. Further layers may be composed of other materials. The second outer layer may consist of a customary material, for example a polyester sheet intended to reduce the permeability to air. Expediently, also the second outer layer consists of the nonwoven fabric material. Intermediate layers of reinforcing filaments or yarns are considered appropriate.

It is of course to be understood that the nonwoven fabric material can also be used and arranged as middle layer in a three- or multi-layer sailcloth.

Preferred reinforcing filaments are in the form of so-called warp sheets, i.e. unidirectionally and nearly parallelly arranged filaments of a spreading out multi-filament yarn. Such warp sheets have proven capable of withstanding extreme stresses and lend high tearing resistance and form stability to the sailcloth.

As materials for warp sheets of that kind the materials already described hereinbefore for the nonwoven fabrics are suitable, and furthermore also those materials that are used in particular with a view to reinforcing sailcloth. Appropriate materials are filaments made of thermoplastic materials, for instance polyester, e.g. Vectran®, polyethylene, polypropylene, ethylene vinyl acetate (EVA) copolymer, polyamide (nylon), and the like. Especially suited are also aramid fibers, carbon fibers as well as combinations of these fibers among themselves or with the above cited materials.

Using a nonwoven fabric material of the kind described herein offers a number of advantages. First of all, there is the extremely low mass per unit area that ranges between 20 and 100 g/m² and in particular is approx. 40 g/m². The individual filaments in this case may have a thickness of between 1 and 20 μm. In the event polyester filaments are used for manufacturing an added benefit is the low water absorption tendency as well as a certain degree of porosity causing any water that has gathered, for example also splash water, to be quickly eliminated, i.e. released into the atmosphere.

The filaments extending in longitudinal direction yield high tensile strength, the transversely extending threads of the carrier matrix result in stabilizing the layer of longitudinally arranged filaments. In the event a carrier matrix has been provided, the materials used may also be identical to those employed for the unidirectional or bidirectional filaments.

In accordance with the invention the sailcloth may be provided, aside from two outer layers, with at least one inner layer of reinforcing filaments or reinforcing yarns. As a rule, at least three inner layers of reinforcing filaments or yarns are provided, in certain cases also five or more layers. Said reinforcing filaments or yarns in each individual layer run primarily in parallel to and along the principal load or stress lines as they occur in sails manufactured from the inventive sailcloth. The preferred alignment of the reinforcing yarns in the individual inner layers is 0° relative to the machine direction of the sailcloth, 20 to 40°, 75 to 105° and in particular 0°, 30°, and 90°. Additional layers may, for example, have alignment angles of 330° or 60°.

Suitable materials for the reinforcing filaments or yarns are PES, aramid, HPPE. Carbon fibers may be employed as well. Examples of aramid yarns are Twaron®, Tecnora Black®, and Kevlar®. As LCM yarns especially Vectran® may be used while as HPPE Dyneema® is suitable.

With respect to the outer layers the reinforcing layers are laid in a customary adhesive bed, preferably under tension, wherein the adhesive bed has a mass per unit area ranging between 20 and 40 g/m². Customary thermoplastic adhesives may be used but also reactive adhesives, for example on polyurethane basis.

The density of the yarns in the individual layers varies between 3000 and 15000 dpi and shall take into account the usual requirements, such as for example size of boat, type of sail (main sail, foresail, genoa) and condition of use (wind force).

The individual layers are connected with each other under the influence of heat and pressure.

It is also possible to use different materials for the individual layers. For example, for the outer layers a nonwoven fabric may be combined with a sheet, or nonwoven fabric materials of different mass per unit area may be employed as well. In the inner reinforcing layers yarns consisting of different materials and having different densities may be arranged.

Moreover, aside from layers consisting of nonwoven fabric and warp sheets also woven scrim fabric may be employed. Such woven scrim fabric may be customary woven fabric with its individual threads crossing each other at an angle of 90°, but also special fabric with threads deviating from the 90° pattern configuration. This enables woven scrim fabric to be used the threads of which extending along the principle load or stress lines of a sail. Such off-angle woven fabric may have deviations from the 90° direction of up to 40° (50° in relation to the machine direction).

The use of nonwoven fabric in the outer layer enables protective UV coatings to be applied without any problems and in particular for the inner layers as well, and moreover provides mechanical protection since damage that may be caused to individual fibers will not result in the propagation of the respective defect. All in all, a smoother surface is achieved.

The nonwoven fabric materials forming the outer layers may easily be colored, printed, and also metalized. A water-repellent impregnation can also be provided.

From the sailcloth proposed by the invention sails may be made based on all customary methods, in particular also according to the cross-cut method.

### EXAMPLE

A sailcloth according to the invention was made comprising the following layers:
1. Outer layer of nonwoven fabric with PET fibers aligned at 0° and 90° (machine direction 0°);
2. Layer of 6337 dpi aramid yarn, 0°
3. Layer of 3168 dpi aramid yarn, 30°
4. Layer of 3168 dpi aramid yarn, 90°
5. (Outer) layer of nonwoven fabric material, same as the first layer.

1. A sailcloth with at least one textile layer, characterized in that at least one textile layer consists of a nonwoven fabric material with unidirectionally or bidirectionally aligned filaments.

2. The sailcloth according to claim 1, characterized by two outer layers and at least one inner layer.

3. The sailcloth according to claim 1, characterized in that one outer layer consists of a nonwoven fabric and the other outer layer of a sheet/foil.

4. The sailcloth according to claim 1, characterized in that the two outer layers consist of nonwoven fabric material.

5. The sailcloth according to claim 1, characterized in that the nonwoven fabric has a mass per unit area ranging between 20 and 100 g/m2.

6. The sailcloth according to claim 5, characterized in that the nonwoven fabric has a mass per unit area ranging between 30 and 60 g/m2.

7. The sailcloth according to claim 1, characterized in that the nonwoven fabric comprises filaments aligned in machine direction (0° direction).

8. The sailcloth according to claim 7, characterized in that the nonwoven fabric comprises filaments aligned bidirectionally in 0° direction and in 90° direction.

9. The sailcloth according to claim 1, characterized in that the nonwoven fabric comprises filaments of polyester, polyethylene, polypropylene, ethylene vinyl acetate and polyamide.

10. The sailcloth according to claim 9, characterized in that the nonwoven fabric comprises polyester filaments.

11. The sailcloth according to claim 1, characterized by at least one inner layer of reinforcing filaments or yarns.

12. The sailcloth according to claim 11, characterized by at least three inner layers of reinforcing filaments or yarns.

13. The sailcloth according to claim 12, characterized in that the reinforcing filaments or yarns extend in the machine direction of the nonwoven fabric material at an angle of 0°, 20° to 40° and 75° to 105°.

14. The sailcloth according to claim 12, characterized in that the reinforcing filaments or yarns extend in relation to the machine direction of the nonwoven fabric material at an angle of 0°, 30°, and 90°.

15. The sailcloth according to claim 10, characterized in that the reinforcing filaments or yarns are laid in an adhesive bed.

16. The sailcloth according to claim 15, characterized in that the adhesive bed has a weight ranging between 20 and 40 g/m2.

17. The sailcloth according to claim 11, characterized in that the reinforcing filaments are provided in the form of warp sheets.

18. The sailcloth according to claim 17, characterized in that the reinforcing filaments consist of polyester, polyethylene, polypropylene, ethylene vinyl acetate, polyamide, aramid, carbon fibers or optional combinations thereof.

19. A sail manufactured from sailcloth with at least one textile layer, characterized in that at least one textile layer consists of a nonwoven fabric material with unidirectionally or bidirectionally aligned filaments.

20. The sailcloth according to claim 2, characterized in that one outer layer consists of a nonwoven fabric and the other outer layer of a sheet/foil.
